(19) United States
(12) Patent Application Publication
(10) Pub. No.: US 2011/0187527 A1
(43) Pub. Date: Aug. 4, 2011

(54) PORTABLE TRACKING/LOCATING SYSTEM, METHOD, AND APPLICATION

(76) Inventors: Penny Goodwill, Highland Falls, NY (US); Alan Hyman, Brooklyn, NY (US); Jane Yusko, New York, NY (US)

(21) Appl. No.: 13/018,844

(22) Filed: Feb. 1, 2011

Related U.S. Application Data
(60) Provisional application No. 61/300,486, filed on Feb. 2, 2010.

(51) Int. Cl. G08B 1/08

(52) U.S. Cl. 340/539.13

(57) ABSTRACT

A tracking system including a tracking device and a tracked device. The tracking device includes a smart phone type device with a radio transceiver dongle connected to it through a USB connection. Communications from the traced device to the tracking device (for example, the transceiver in the dongle) take the following form: RF communications that do not travel over a pre-existing communication network (for example, a pre-existing internet network, a pre-existing cell phone network) and that use Multi-Use Radio Service (MURS), xbee (zigBee), FSK, OSK, ISM Band standards that provide two-way radio frequency spectrum, or any frequency available thru Federal Communications Commission (“FCC”) 47 Code of Federal Regulations (“C.F.R.”) §15, or any available frequency that is sanctioned for long distance use (e.g., 0.5 miles or more, 300 meters or more) by the appropriate governing body, rather than Bluetooth radio communications, or any other type of RF communications that can only transmit, as a practical matter under normal operating conditions, less than 300 feet.

### RELATED APPLICATION

The present application claims priority to U.S. provisional patent application No. 61/300,486, filed on Feb. 2, 2010; the subject matter of which is incorporated herein by reference in its entirety.

### FEDERALLY SPONSORED RESEARCH OR DEVELOPMENT

Not applicable.

### BACKGROUND OF THE INVENTION

1. Field of the Invention

Embodiments of the invention are most generally related to the field of object tracking or locating a known object with unknown whereabouts. More particularly, embodiments of the invention are directed to a system that includes a portable (i.e., handheld), non-dedicated/non-tracker-specific/multi-function component assembly that may be used to identify the unknown location(s) of a known object(s), as well as to methods pertaining thereto and applications thereof. Most particularly, embodiments of the invention are directed to systems, methods and applications that provide a ‘smart phone’-type device or other non-tracker-specific-type device with the capability to locate and identify the unknown location(s) of a known object(s).

2. Description of the Related Art

Various commercially available, dedicated tracker/locator devices/systems provide some degree of capability to track or locate a person or pet. These include the RoamEO™ pet locator system, the Loc8tor™ locating system, the Zoombak® personal GPS locator, and others. A non-exhaustive list of attributes and needs/requirements for these devices include the following: they tend to be tracker-dedicated devices (meaning that the device used to track the object of interest from a remote location is a dedicated tracking device and does not have substantial functionality in addition to its tracking-related functionality); they depend on available cellular connectivity and/or available internet connectivity; they require a fee-based GPS service and/or a computer and/or a customer service interface; they may utilize relatively large tracker components; and they may require various recurring service fees.

In view thereof, the inventors have recognized the benefits and advantages that would be provided to society by apparatus and methods that lessen or eliminate the aforementioned needs/requirements and the shortcomings associated therewith. However, some prior art tracking systems do contemplate the use of a smart phone as a component of the tracking device. These smart phone based prior art tracking systems will be discussed now below.

In some smart phone based prior art tracking systems, communications from the tracked device to the tracking device are necessarily communicated over pre-existing network communication hardware that exists along the data communication path from the tracked device to the tracking device. For example, in some prior art tracking system, the tracked device communicates its position through the internet. In such prior art, the communications may pass through a central server, but they will always be passing through some hardware that is extraneous to the tracked and tracking devices. This can be helpful in that it can allow communications from a tracked device to a tracking device over a long distance. On the other hand, it requires that both the tracked device and tracking device: (i) have access to the network from a geographical perspective; and (ii) have access to the network in the sense of paying a network service provider for the service of access to the network.

In other smart phone based prior art tracking systems, Bluetooth radio communications are used when the tracked device communicates its position data to the tracking device. However, Bluetooth has some serious shortcomings such as relatively large power consumption and relatively short range. More specifically, Bluetooth is only rated for a distance of 300 feet at most (and many Bluetooth links have a much shorter range in practice).

Description Of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, reflect subject matter developed early enough in time, be sufficiently publically accessible and/or be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

Some aspects of the present invention are directed to a tracking system where the tracking device includes a computer, such as a tablet, laptop, desktop or smart phone, and the tracked device communicates with the tracking device by “long range direct radio communication,” which is a term that will be further discussed below. Other aspects of the present invention are directed to a dongle-style peripheral device that can: (i) be connected in data communication (for example, USB connected) with a computer (for example, a smart phone); and (can receive long range direct radio communications from a tracked device.

A tracking system including: a tracking device; and a tracked device. The tracking device includes a computer and a base radio receiver. The computer includes tracking software. The tracked device comprises a position determination sub-system and a tracked radio transmitter. The position determination sub-system is structured and/or connected to determine positional information relating to the location of the tracked device and to communicate this information to the tracked radio transmitter. The base radio receiver and tracked radio transmitter are structured so that the tracked radio transmitter transmits the positional information to the base radio receiver by long range direct radio communication. The base radio receiver is structured and/or connected to communicate the positional information to the tracking software. The base radio receiver and tracked radio transmitter are structured so that the tracked radio transmitter transmits the positional information to the base radio receiver by long range direct radio communication or over a mesh network. A mesh network tracking system being defined as a tracking system where at least one client node (that is, tracking device or tracked device) can act as a server, router or relayer and effectively relay information received directly from another client node to other client nodes.

A tracking kit sub-system is used in a larger tracking system including a smart phone type device including a user interface. The tracking kit sub-system including: tracking software; a dongle; and a first tracker. The dongle includes a radio transceiver. The dongle is connectable to the smart phone type device by a wired data communication connection. The tracking software is programmed to be installable on and to run on the smart phone type device. The first tracker comprises a Global Positioning System sub-sub-system and a radio transceiver. The Global Positioning System sub-sub-system is structured and/or connected to determine positional information relating to the location of the tracked device and to communicate this information to the radio transceiver of the first tracker. The radio transceiver of the first tracker and the radio transceiver of the dongle are structured so that the radio transceiver of the first tracker transmits the positional information to the radio transceiver of the dongle by long range direct radio communication. The radio transceiver of the dongle is structured and/or connected to communicate the positional information to the tracking software, when connected to the smart phone device, through the wired data communication connection. The tracking software is programmed, when installed and running on the smart phone type device, to communicate the positional information to the user interface so that the positional information will be output by the user interface in human readable form.

A method is performed by processing hardware of a computer programmed to provide functionality of tracking remote objects in conjunction with user interface, a long range direct radio transceiver, a Global Positioning System sub-system and an internet network communication sub-system. The method includes the following initial steps (not necessarily in the following order): (a) selecting, by the user through the user interface, of a remote object to track; (b) determining which of the following alternative conditions is applicable: condition (i) the long range direct radio transceiver, the Global Positioning System sub-system and the internet network communication sub-system are all available; condition (ii) the long range direct radio transceiver and the Global Positioning System sub-system are available, but the internet network communication sub-system is not available; or condition (iii) the long range direct radio transceiver is available, but the Global Positioning System sub-system and the internet network communication sub-system are not available; and receiving positional information of the remote tracked object by the long range direct radio transceiver through long range direct radio communications from the remote tracked object. After the initial steps are performed, and depending upon which condition is determined at the determining step, a set of conditional sub-steps (Condition (i) Sub-steps, Condition (ii) Sub-steps or Condition (iii) Sub-steps) is performed. Condition (i) Sub-steps: assembling positional relating to the remote tracked object received at the receiving step by the long range direct radio transceiver with information from the Global Positioning sub-sub-system and the internet network communication sub-sub-system to generate a condition (i) type display indicating the position of the remote tracked object, and displaying the condition (i) type display through the user interface in human readable form. Condition (ii) Sub-steps: assembling positional relating to the remote tracked object received at the receiving step by the long range direct radio transceiver with information from the Global Positioning sub-sub-system to generate a condition (ii) type display indicating the position of the remote tracked object, and displaying the condition (ii) type display through the user interface in human readable form. Condition (iii) Sub-steps: generating a condition (iii) type display indicating the position of the remote tracked object received at the receiving step by the long range radio transceiver, and displaying the condition (iii) type display through the user interface in human readable form.

### BRIEF DESCRIPTION OF THE DRAWINGS

The present invention will be more fully understood and appreciated by reading the following Detailed Description in conjunction with the accompanying drawings, in which:

FIG. 1 is a schematic view of a first embodiment of a tracking system according to the present invention;

FIG. 2 is a schematic view of a first embodiment of a tracking system according to the present invention;

FIG. 3 is a screen shot view of a first embodiment of a tracking display according to the present invention;

FIG. 4 is a screen shot view of a second embodiment of a tracking display according to the present invention;

FIG. 5 is a schematic view of a third embodiment of a tracking system according to the present invention;

FIG. 6 is a flowchart showing a portion of an embodiment of a first method according to the present invention;

FIG. 7 is a flowchart showing another portion of the first method;

FIG. 8 is a flowchart showing another portion of the first method;

FIG. 9 is a flowchart showing a portion of an embodiment of a second method according to the present invention;

FIG. 10 is a flowchart showing another portion of the second method;

FIG. 11 is a flowchart showing another portion of the second method;

FIG. 12 is a flowchart showing another portion of the second method;

FIG. 13 is a flowchart showing an embodiment of a third method according to the present invention;

FIG. 14 is a flowchart showing an embodiment of a fourth method according to the present invention; and

FIG. 15 is a flowchart showing an embodiment of a fifth method according to the present invention;

FIG. 17 is a flowchart showing a portion of a variation on the second method;

FIG. 18 is a flowchart showing another portion of the variation on the second method;

FIG. 19 is a flowchart showing another portion of the variation on the second method; and

FIG. 20 is a flowchart showing another portion of the variation on the second method.

FIG. 21 is a schematic of a first embodiment of a mesh network tracking system.

FIG. 22 is a schematic of a second embodiment of a mesh network tracking system.

FIG. 23 is a schematic of a third embodiment of a mesh network tracking system.

### DETAILED DESCRIPTION OF THE INVENTION

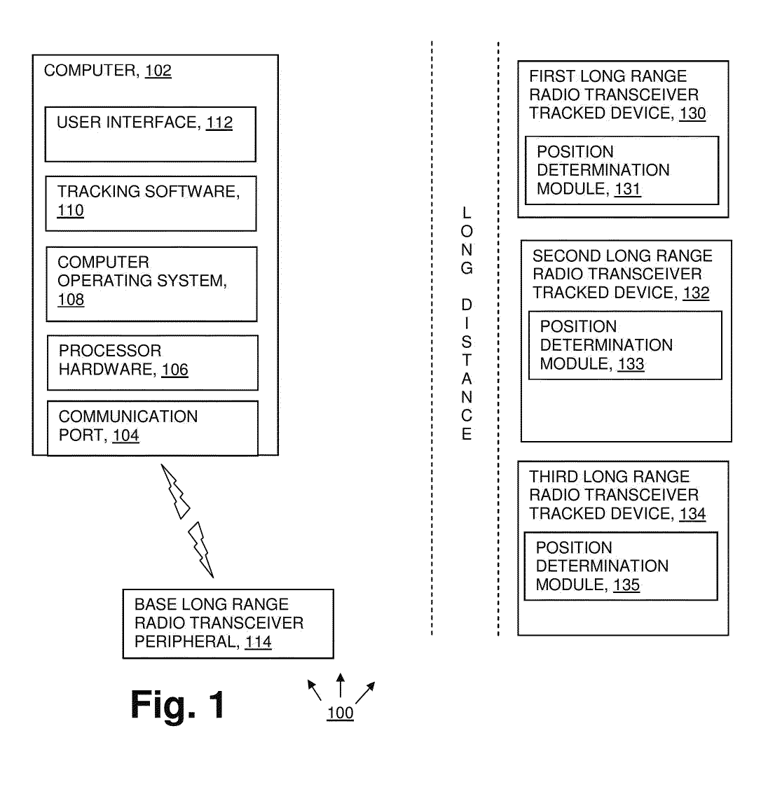

FIG. 1 shows tracking system 100, including: computer 102; base long range radio transceiver peripheral device 114; first long range radio transceiver tracked device 130; second long range radio transceiver tracked device 132; and third long range radio transceiver tracked device 134. Computer 102 includes: communication port 104; processor hardware 106; computer operating system 108; tracking software 110; user interface 112.

Computer 102 is not a dedicated device that is only capable of use in a tracking system. Rather, computer 102 is a multi-function computer, such as a desktop computer, laptop computer, netbook computer, mini netbook computer, tablet computer or smart phone. As used in this document, “computer” shall mean any multi-function device that runs a computer operating system (of any type now known or developed in the future) provides a standardized interface and platform for applications, such as an operating system designed for desktop computers (example, UBUNTU LINUX, MAC OS X) or an operating system designed for smart phones (example, GOOGLE ANDROID, iOS). (Note: the terms “UBUNTU,” “GOOGLE,” “iOS,” “MAC OS X” and/or “ANDROID” may be subject to trademark rights in various jurisdictions throughout the world and are used here only in reference to such trademarked products or services to the extent that such trademark rights may exist.) It can be advantageous to use a multi-function computer as a base station because many consumers will already have a computer (and operating system) on hand in one form or another, and they will need to be provided less hardware and/or software when they make a complete tracking system using their pre-existing computer (for example, smart phone). This is a difference between some embodiments of the present invention and some of the prior art discussed above.

Base long range radio transceiver peripheral device 114 sends and receives “long range direct radio communications” which is herein defined to be: RF communications that do not travel over a pre-existing communication network (for example, a pre-existing internet network, a pre-existing cell phone network) and that use Multi-Use Radio Service (MURS), xbee (zigBee), FSK, OSK, ISM Band standards that provide two-way radio frequency spectrum, or any frequency available thru Federal Communications Commission (“FCC”) 47 Code of Federal Regulations (“C.F.R.”) §15, or any available frequency that is sanctioned for long distance use (that is, 300 feet or more) by the appropriate governing body; long distance direct radio communications do not include Bluetooth radio communications, or any other type of RF communications that can only transmit, as a practical matter under normal operating conditions, over 300 feet or less. It is potentially advantageous that the long range direct radio communications of some embodiments of the present invention are direct, and not networked, because that means that the operation of the present invention does not rely on network infrastructure for its tracking-related communications. It is potentially advantageous that the long range direct radio communications of some embodiments of the present invention are long range and not short range because tracked objects may travel long distances from the base unit, and this is true whether the base unit is relatively stationary (like a desktop computer) or relatively mobile (like a smart phone).

In system 100, transceiver 114 is in the form of a wireless peripheral device that communicates with wireless communication port 104 of the computer. As will be discussed below, this transceiver could be connected through a USB wired communication port, or it could be built right in to the main housing of the computer. In some embodiments the data communication connection between the peripheral transceiver and the computer of the tracking sub-system will be proprietary, and in other embodiments it will be non-proprietary. In some embodiments of the present invention, the data that is communicated from the transceiver peripheral will be translated in the peripheral from raw radio waveforms into numerical information representing physical location. In other embodiments, the computer may receive data that corresponds un-demodulated radio waves where the positional data has not been extracted from the radio communication received at transceiver 114. In some embodiments the data communicated from the peripheral to the computer of the tracking sub-system will be in the form of serial communication packetized protocol data. In some embodiments, and especially in embodiments where the computer is a smart phone that is not usually plugged into a utility power source, the peripheral transceiver of the tracking sub-system may have its own power source, such as a consumable battery and/or a rechargeable battery. As will be further discussed below, some embodiments of the present invention are smart phones with transceivers in the form of USB dongles, or dongles that connect to the smart phone through other types of data communication hardware (now known or to be developed in the future). In some embodiments, the data is transmitted via IEEE standards which have been approved for radio transmission. In some embodiments, the data gets translated to and from the dongle and tracker via already published methods and standards. In some embodiments, this data is packetized during transmission from the tracked device to the tracking device. When the data reaches it's destination it gets translated in the peripheral and/or in the computer. The translating process could include, but not limited to, encryption schemes.

As shown in FIG. 1, each of the tracked devices 130, 132, 134 respectively includes a position determination module 131, 133, 135. the position determination module determines position in any way now known or to be developed in the future. One exemplary, non-limiting way is GPS, but other ways of position determination may include cell tower triangular, determination based on ambient signals WiFi or other wireless communication networks, determination based on ambient AM or FM radio signals, determination based on magnetism, etc. It is noted that some of these position determination schemes may be less than optimal for some applications in that: (i) they rely on available, proximate network infrastructure of various types; and/or (ii) they may not provide the precise, accurate and/or comprehensive global coverage that is typical of GPS.

After the position determination modules of each tracked device determine position, this data is sent as a long range direct radio communication to base long range radio transceiver peripheral device 114, which, in turn, relays this information to tracking software 110 so that a user may know the positions of the three tracked devices through user interface 112. There could be more than three tracked devices, and there could be additional tracking devices as a well. In some embodiments of the present invention, there will be two way long range direct radio communications between base long range radio transceiver peripheral device 114 and the tracked devices. It is noted that while these two way radio long range direct radio communications may be considered as forming a small network (sometimes called a mesh network) in and of themselves, but they are still considered as “direct radio communications” for purposes of this document rather than “network radio communications” because the tracked-device-to-base communications do not rely on pre-existing communication network infrastructure that is extraneous to the tracking system itself. To put it another way, in a so-called “mesh network” no communications are relayed through intermediate hardware as they are communicated from the tracked device to the tracking device. This is why a so-called “mesh network” is still long range direct radio communication for purposes of this document.

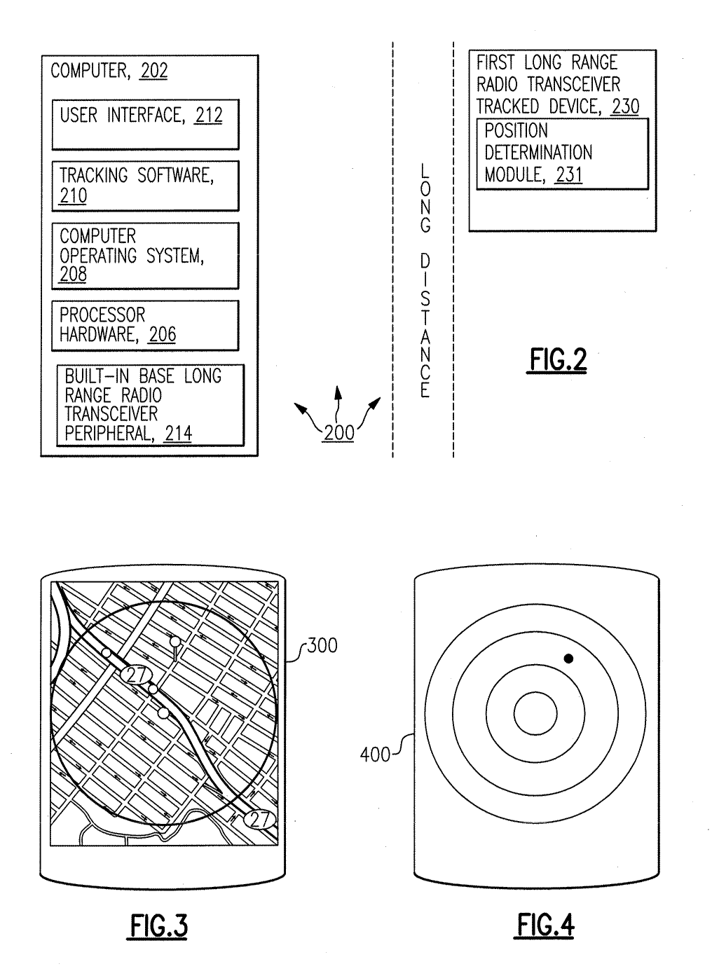

FIG. 2 shows tracking system 200, including: computer 202; first long range radio transceiver tracked device 230; and position determination module 231. Computer 202 includes: communication port 204; processor hardware 206; computer operating system 208; tracking software 210; user interface 212; and built-in long range radio transceiver 214. System 200 is generally similar to system 100 except that base station's transceiver is an internal device instead of taking the form of a peripheral device. The computer is still multi-purpose, as discussed above, and it still may take the form of a smart phone with a smart phone type computer operating system. While smart phones are not believed to currently be built with long range direct radio communication transceivers, this may change in the future. The communications between the base station and the tracked objects are still long range direct radio communications.

An embodiment of the invention pertains to a tracker/locator system that includes a portable (i.e., handheld), non-dedicated/non-tracker-specific/multi-function apparatus assembly that can be used to identify the unknown location(s) of known object(s). Non-limiting examples of a primary component of such a non-dedicated/non-tracker-specific/multi-function apparatus assembly includes smart phones (e.g., iPhone/Apple; Droid/Motorola; Storm and others/BlackBerry; others), media players (e.g., iPod Touch music player; others), tablet computers, and others known in the art. Such component may operate in combination with a dongle, and operates also with a tracker component. (Note: the terms “iPhone,” “Apple,” “Droid,” “Motorola,” “Storm,” “BlackBerry,” “iPod,” and/or “iPod Touch” may be subject to trademark rights in various jurisdictions throughout the world and are used here only in reference to such trademarked products or services to the extent that such trademark rights may exist.)

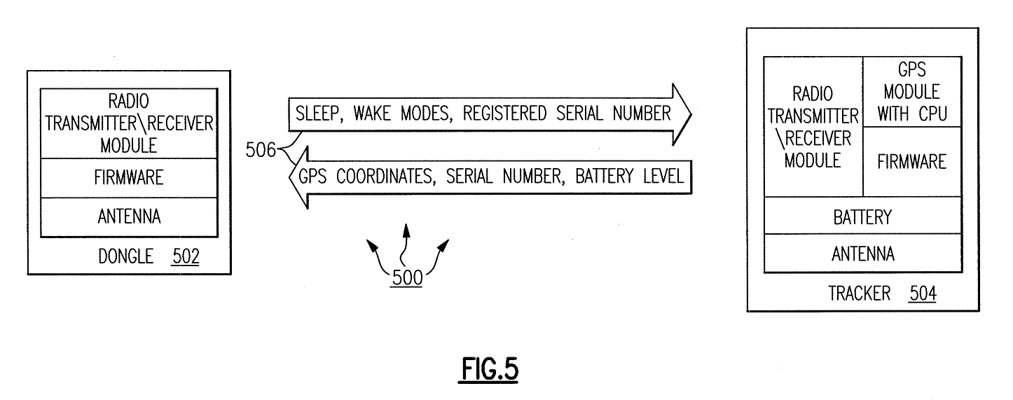

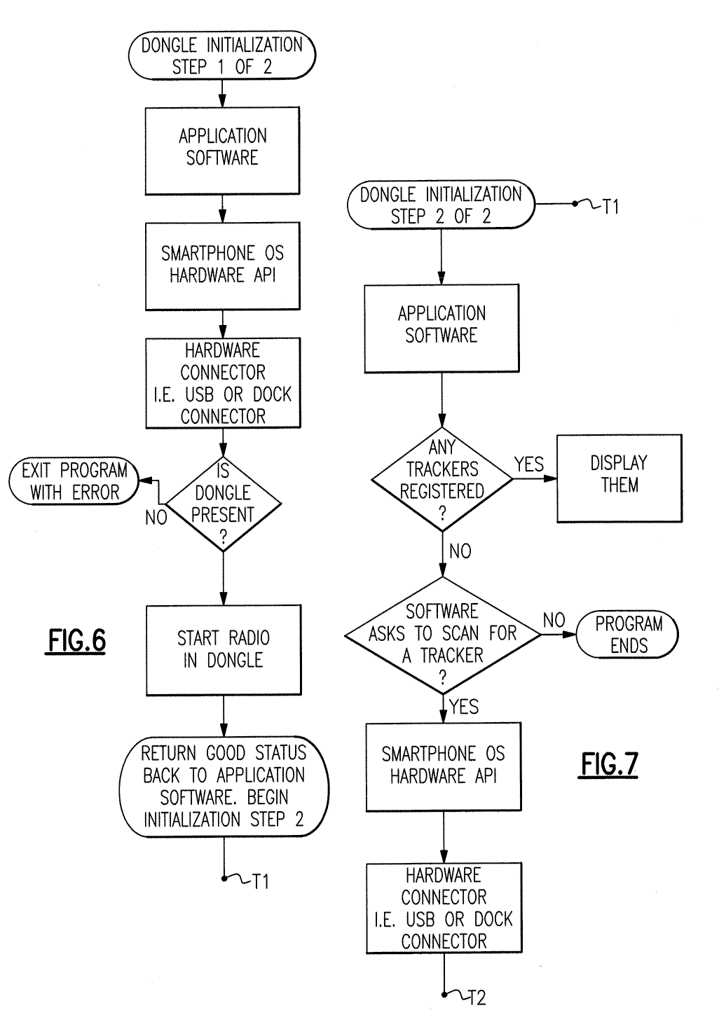

For simplicity and ease of understanding, the non-limiting exemplary and illustrative embodiments of FIGS. 3, 4 and 5 will be described below in conjunction with a smart phone type device with a USB connected dongle 502. As shown in FIG. 3, the tracking “app” of the smart phone type device (not shown because it is well known what smart phones look like), which serves as a base station, may produce a screen display 300 that shows the base station and the tracked device as two dots on a road map. As shown in FIG. 4, the tracking “app” of the smart phone type device (not shown), which serves as a base station, may produce a screen display 400 that shows the tracked device on a co-ordinate grid (in this case an angular-radial grid). As shown in FIG. 5, tracking system 500 includes: dongle 502 (including radio transmitter/receiver module, firmware and antenna); tracker (that is, tracked device) 504 (including radio/transmitter receiver, GPS module with CPU, firmware, battery and antenna); and wireless long range direct radio communication signals 506. Signals 506 include sleep commands, wake command, and registered serial number polling data communicated from the dongle to the tracker. Signals 506 further include GPS co-ordinates, serial number identification data, and battery level data from the dongle to the tracker. The GPS co-ordinates that are communicated from the tracker to the dongle (and its associated smart phone type device and smart phone app) allow a user at the smart phone type base station to know the location of the tracked device on an ongoing basis. It is emphasized that these kinds of displays are non-limiting and any future type of display (for example, three dimensional display) or other tracking information communication form (for example, audio communication to the user, brain-computer direct interface style communication to the user), now known or to be developed in the future, may be used.

Although there appears to be no industry standard definition of a “smart phone,” the term “smart phone type device” will be defined herein to refer to any mobile telephone offering advanced capabilities and having PC-like functionality (e.g., PC-mobile handset convergence) or, to a mobile phone that runs complete operating system software and provides a standardized interface and platform for applications. Examples of current smart phone type devices, operating systems, and manufacturers include, but are not limited to, the Apple iPhone, Android, Linux, Windows Mobile OS, Blackberry, LG Electronics, HP, Motorola, and others. (Note: the terms “Apple iPhone,” “Android,” “Linux,” “Windows Mobile OS,” “Blackberry,” “LG Electronics,” “HP,” and/or “Motorola” may be subject to trademark rights in various jurisdictions throughout the world and are used here only in reference to such trademarked products or services to the extent that such trademark rights may exist.)

An embodiment of the invention is directed to a portable tracking/locating system that includes a smart phone-type device, wherein the smart phone-type device includes an accessible wireless radio protocol; and a tracker component associated with (i.e., connected or attached to) the object to be tracked/located. The object to be tracked/located is not a part of the invention per se, and will be understood to be a person, an animal, or an inanimate object (e.g., key ring, car) to which the tracker can be attached or connected to. According to this embodiment, certain application programming interfaces (APIs) and mapping/tracking and other applications (APPs) (e.g., Compass, Augmented Reality, GPS, Google Maps, email, and others known in the art) are, or can be, programmed into the smart phone-type device using, e.g., an appropriate Software Development Kit (SDK). Custom libraries that are made specific to the tracker/locator application can be installed, which will enable the interaction of the smart phone type device with the tracker component. The library will be designed to handle the communication between the particular smart phone or tablet software interface and the dongle, Various operational aspects of the library may include: (i) opening the communication channel to the dongle; (ii) reading information from the dongle that is received from the tracker including, but not limited to, latitude, longitude, GPS coordinate data, tracker ID information (e.g., serial number), signal strength, tracker battery level, and other data; (iii) sending commands to the tracker from the dongle; and (iv) other commands and/or data.

In system 500 the tracker includes a radio transmitter/receiver module (including RF chip), a GPS module, a self-contained power source (battery), and appropriate firmware pertaining to GPS coordinate data, tracker ID information (e.g., serial number), signal strength, tracker battery level, distance information via RF, and other data. In the non-limiting, exemplary embodiment of system 500 the position-related communications are made from the tracked device to the tracking device by ZigBee type radio communications. (The name “ZIGBEE” may be subject to trademark rights and/trademark registrations in various jurisdictions throughout the world.) ZigBee/xBee radio communications are typically transmitted at 900 mhz or 2.4 ghz. ZigBee typically operates in the industrial, scientific and medical (ISM) radio bands; 868 MHz in Europe, 915 MHz in the USA and Australia, and 2.4 GHz in most jurisdictions worldwide. Zigbee technology may be advantageous because it is intended to be simpler and less expensive than other WPANs such as Bluetooth. ZigBee chip vendors typically sell integrated radios and microcontrollers with between 60 KB and 256 KB flash memory, such as the Jennic JN5148, the Freescale MC13213, the Ember EM250, the Texas Instruments CC2530 and CC2520, the STMIcroelectronics STM32W, the Samsung Electro-Mechanics ZBS240 and the Atmel ATmega128RFA1. Radios are also available as stand-alone components to be used with any processor or microcontroller. Generally, chip vendors also offer the ZigBee software stack, although independent ones are also available.

A related embodiment of the invention is directed to a portable tracking/locating system that includes a smart phone type device, a dongle connectable to the smart phone-type device; and a tracker component associated with the object to be tracked/located. In this embodiment, the smart phone-type device lacks an accessible wireless radio protocol, which is now provided by the dongle, and which can be connected to the smart phone-type device via a standard or custom connecter (e.g., dock connector; USB; others known in the art). The dongle includes a radio transmitter/receiver module to facilitate bidirectional RF transmission between the dongle and the tracker, an antenna, and appropriate firmware to communicate with selected applications (APPs) installed on the smart phone type device.

According to a non-limiting, illustrative example of operation and with reference to FIG. 5, a tracker 504 is placed on the object to be tracked (note that multiple trackers may be placed on respective multiple objects to be tracked). The desired mapping software will be resident on the smart phone type device that is USB connected to dongle 502, installed on the smart phone from an external source and/or installed and run on a remote computer that is in communication with the smart phone (for example, a cloud server).

When the installed library software is started for the first time, the user will be prompted to register tracker 504. The software will instruct dongle 502 to listen on a specific frequency range for any tracker having a serial number belonging to the user that is not registered in its database that is accessible by the tracker app software. This database may be located on the smart phone type device itself, or it may be located on a remote storage device that is in data communication with the smart phone type device. If the serial number polling of the smart phone type device and its associated dongle finds a signal from a tracker belonging to the user, then the tracking app software will ask the user to give the discovered tracker a name. The name may be used as a friendly, or mnemonic, way to refer to a specific tracker, and the database is updated to reflect the registered status of the discovered tracker and its user-friendly name.

When an object with an attached tracker is desired to be located, the user selects its name from the list in the database to start the tracking process. The tracker may have different power states to save power. The smart phone's library software sends a message to the dongle to send a signal to the tracker to wakeup. At regular intervals the tracker will wake up to broadcast its location information. The dongle captures the transmission and the smart phone's custom library software will display the location information through one of three interfaces: (i) Radio Frequency interface utilizing the smart phone's built in compass—using, e.g., Augmented Reality view; (ii) Radio Frequency interface utilizing the smart phone's built in compass and built in GPS—using, e.g., Augmented Reality view; or (iii) utilizing the GPS with Internet connectivity on the smart phone (when Internet and GPS connectivity are available)—allowing overlay on a map or, e.g., Augmented Reality view (using, e.g., the smart phone's built in compass). Thus if cellular Internet is available, maps are downloaded to enhance tracking experience (GPS coordinates of the smart phone device and the tracker can both be shown on a on the map on a display of the smart phone type device as shown in FIG. 3). Augmented reality is a term for a live direct or indirect view of a physical, real-world environment whose elements are augmented by computer-generated sensory input, such as sound or graphics. It is related to a more general concept called mediated reality, in which a view of reality is modified (possibly even diminished rather than augmented) by a computer. As a result, the technology functions by enhancing one's current perception of reality. By contrast, virtual reality replaces the real-world with a simulated one. Augmentation is conventionally in real-time and in semantic context with environmental elements.

FIG. 4 provides a similar representative screen shot of the smart phone type device wherein the smart phone-type device may not have Internet access. Thus if cellular Internet is not available, then a local store of maps can be used (GPS coordinates are interpreted on the map for both the remote tracker and smart phone device).

The user will have the option to view an interface, which displays the direction of the remote tracker in relation to the smart phone device. This will work regardless of the cellular Internet connection or the GPS signal availability. Some embodiments will further include hardware structured and connected to provide a sound emission capability to the tracker, which capability may be activated by the tracking device. For example, a user operating the tracking device may choose to activate the sound capability when GPS is not available.

Finally with respect to the embodiment of FIGS. 3-5 it is noted that the positional-related communications from the tracker to the smart phone type device are long range direct radio communications (as that term is defined above). The tracker may make other types of data communications. For example, it may receive GPS communications from a GPS satellite (not shown). As a further example, the tracker could have built-in hardware or software for calling 911 on a network (for example, a cell telephone network). As a further example, disused smart phones (for example, old, obsolete smart phones) may be used as a basis for making tracking devices. For example, a parent may make her child a tracked device using her old disused smart phone and a dongle transmitter. In this way, the logic for the tracked device can be provided as software, rather than new, dedicated hardware. This may bring down the cost of making tracked devices. Now, under this sort of plan, the disused smart phone would likely have GPS capabilities as well as capabilities to make calls on cell telephone networks and internet networks. However, the parent may or may not want to activate these capabilities in the tracked device due to cost concerns and/or to the parent's perception is ready for a cell telephone and/or internet device. The smart phone device is also, of course, capable of making non-long-range-direct-radio-communications, as it would, for example, every time it is used to connect to a data communication network to perform the non-tracking related functions it has. However, none of these additional possible communications capabilities should be allowed obscure the fact that the tracker can make long range direct radio communications with a dongle that is USB connected to a smart phone type device having tracker software installed upon it.

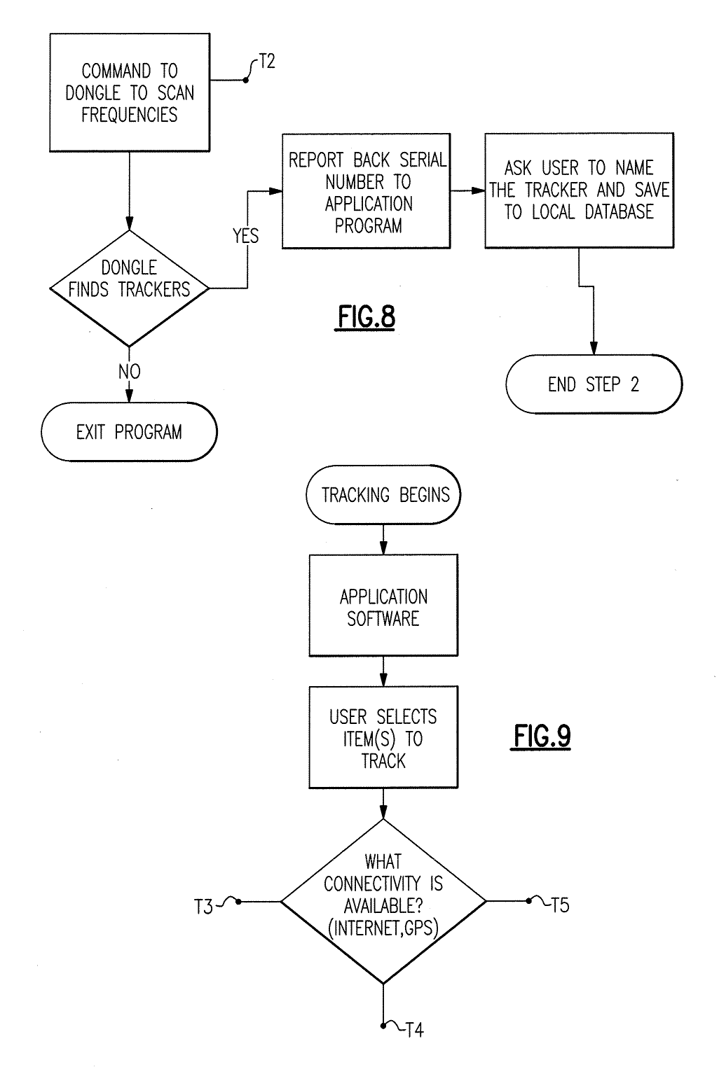

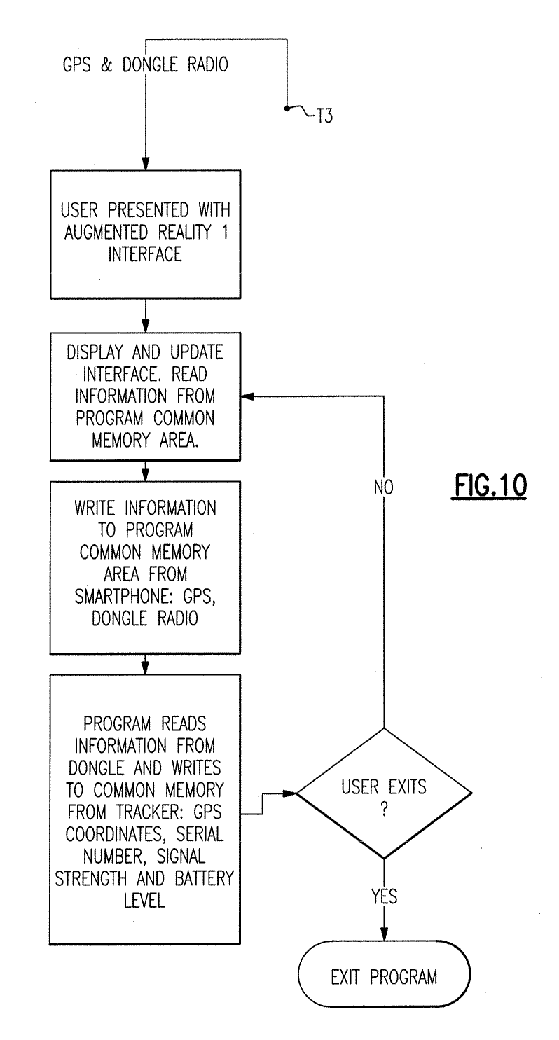

FIGS. 6-8 show the steps in a method of initializing a dongle using the tracking app on the smart phone type device. This method includes steps to make sure the long range direct radio communication transceiver in the dongle is working properly (see FIG. 6). This method further includes steps to determine whether trackers are registered and/or determine whether the user wishes to scan for registerable trackers (see FIG. 7). This method further includes steps to scan for and register new trackers (see FIG. 8).

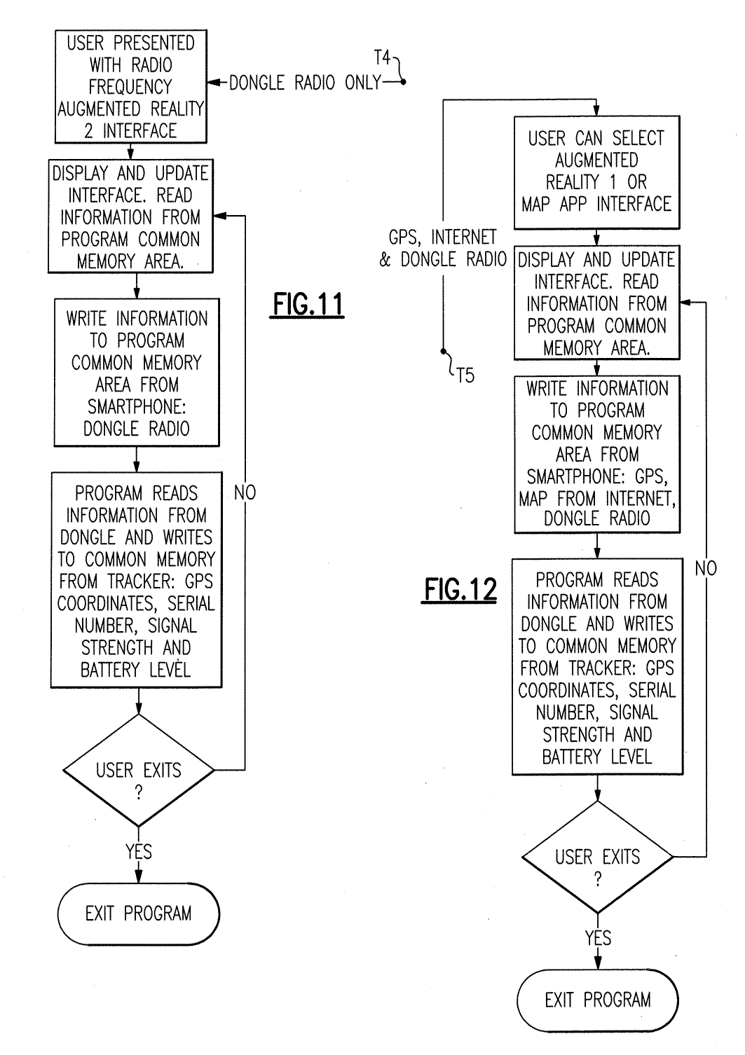

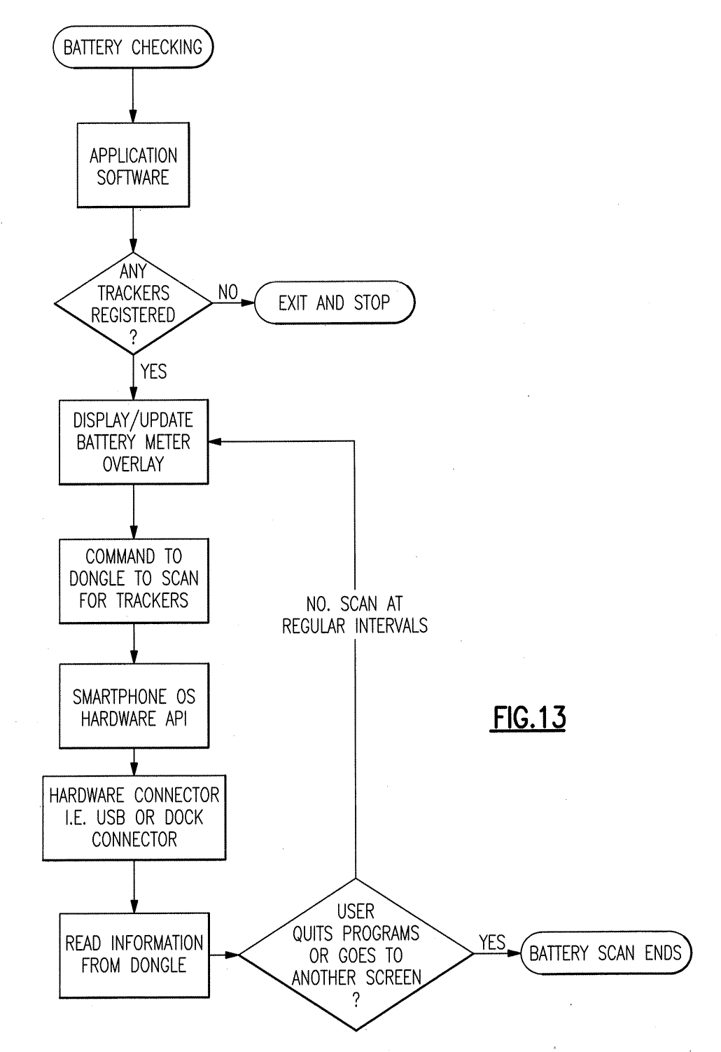

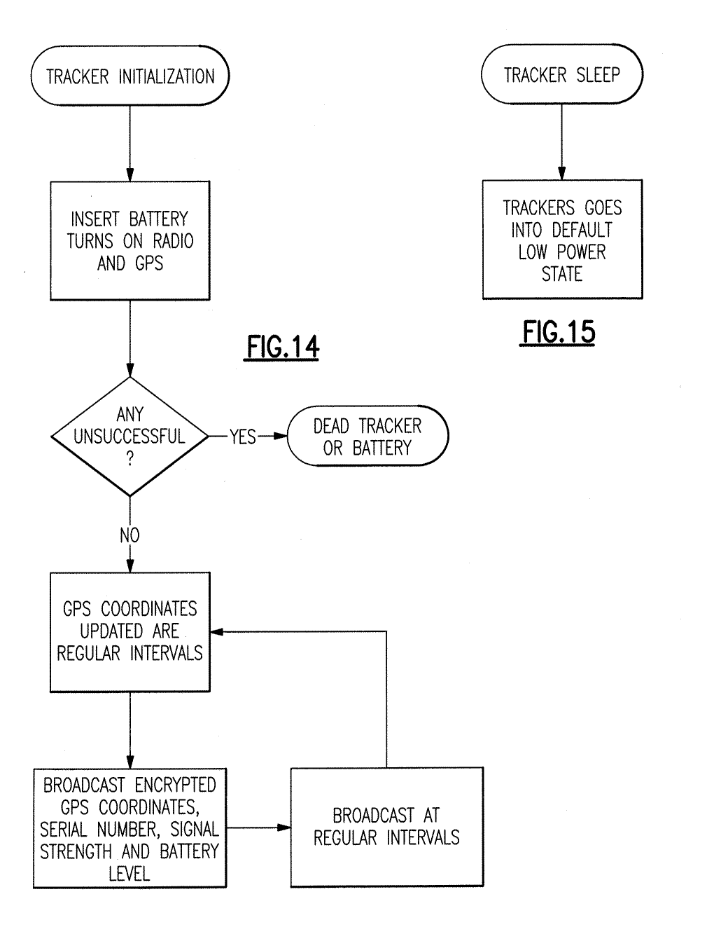

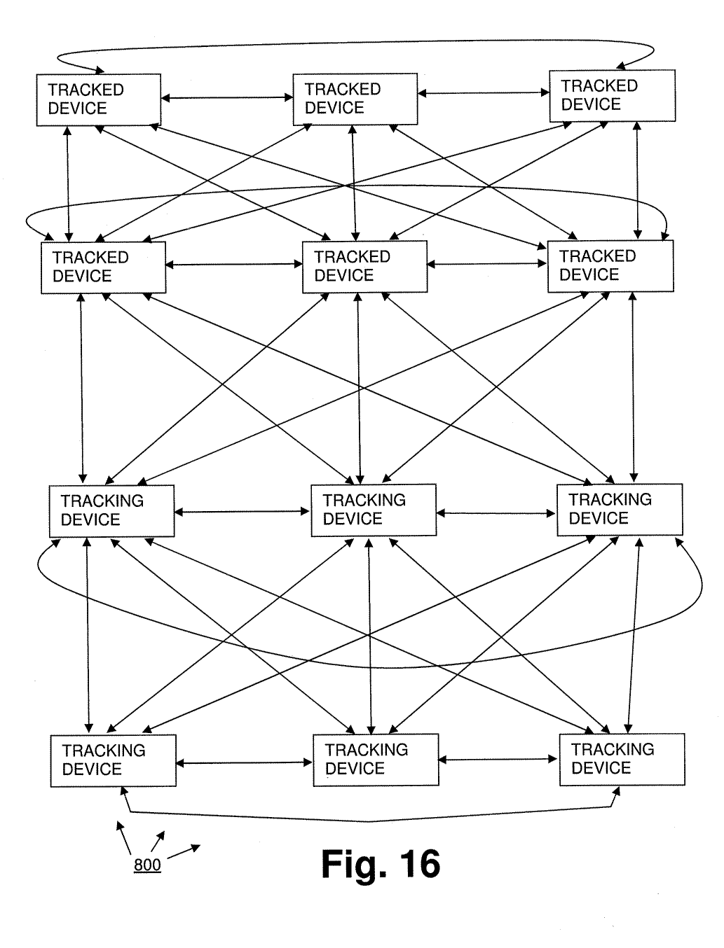

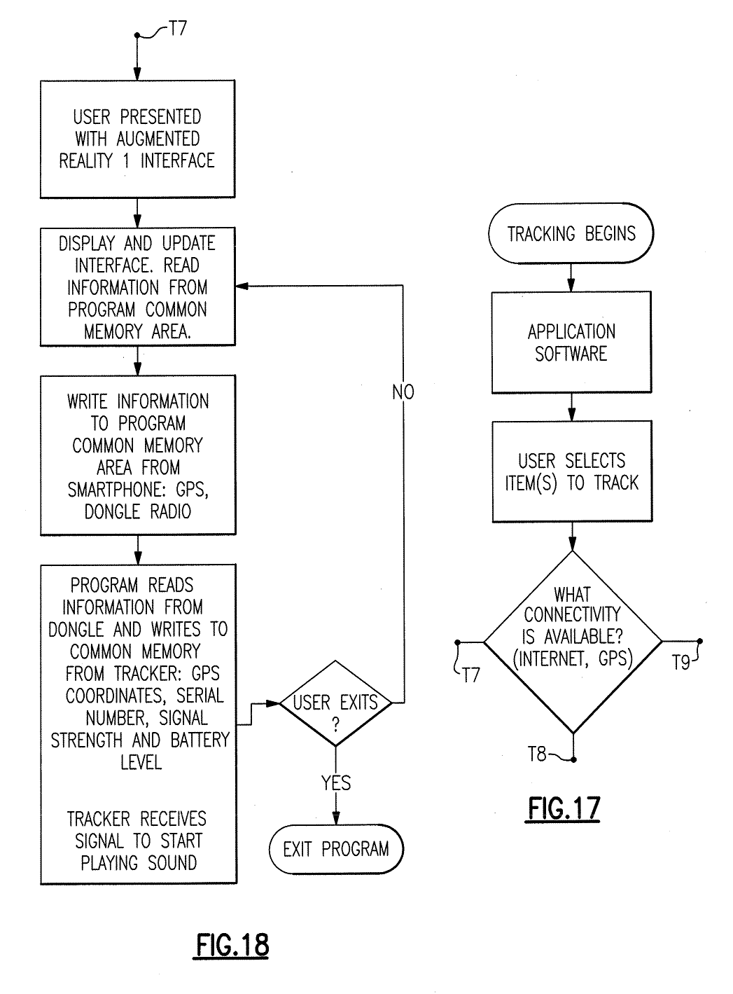

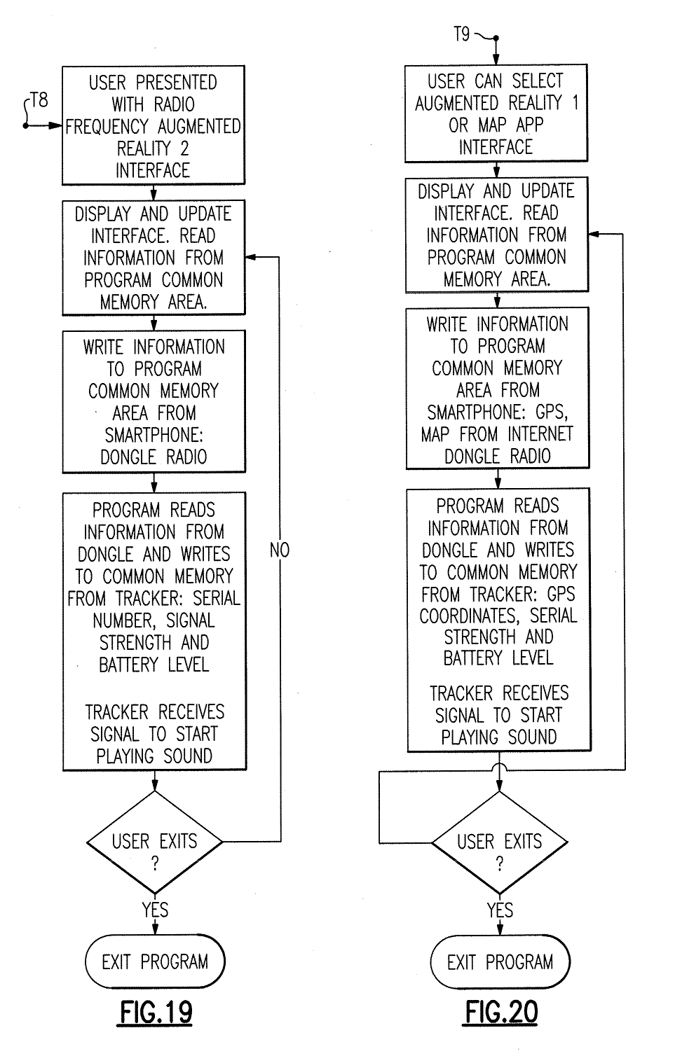

FIGS. 9-12 show the steps in a method of tracking. This method includes steps to determine what trackers are to be tracked and what types of connectivity the smart phone device has available to for providing information to display in the user interface along with the location of the tracked device(s) (herein called “UI background information”) (see FIG. 9). This method further includes steps for obtaining UI background information when both the smart phone type device's GPS sub-system and its USB connected dongle transceiver are present (see FIG. 10). This method further includes steps for obtaining UI background information when only the USB connected dongle transceiver is present (see FIG. 11). This method further includes steps for obtaining UI background information when the smart phone type device's GPS sub-system, its USB connected dongle transceiver and its internet data communication sub-system are all present and operating (see FIG. 12). FIGS. 17-20 show a variation on the method of FIGS. 9-12. In the variation of FIGS. 17-20, sound is selectively emitted from the tracker to help locate it.

It will be appreciated that different smart phone type device manufacturers may have different interface requirements that could affect aspects of the dongle, according to an exemplary embodiment. For example, Apple currently requires that makers of accessories join their licensing program called Made for iPhone. In such instance, the system may require from Apple an authentication chip and dock connector.

Google, for example, on the other hand, does not require a license nor an authentication chip; their operating system is open source. Another manufacturer may require their own proprietary connector and/or chips and/or software APIs. Alternatively, a manufacturer may not have any interface requirements thus allowing standard interface connections such as USB (including mini-USB, micro-USB, and other USB types).

If a new wireless or connection standard is introduced, embodiments of the invention may be able to use these and eliminate the dongle component. For example, Apple currently does not make available APIs for certain FM frequencies included but not supported in their chip set that could be utilized by the embodied invention. If such support did exist, the tracker component of the invention could include a chip to support that frequency, thus moving the function provided by the dongle to the application software on the smart phone device.

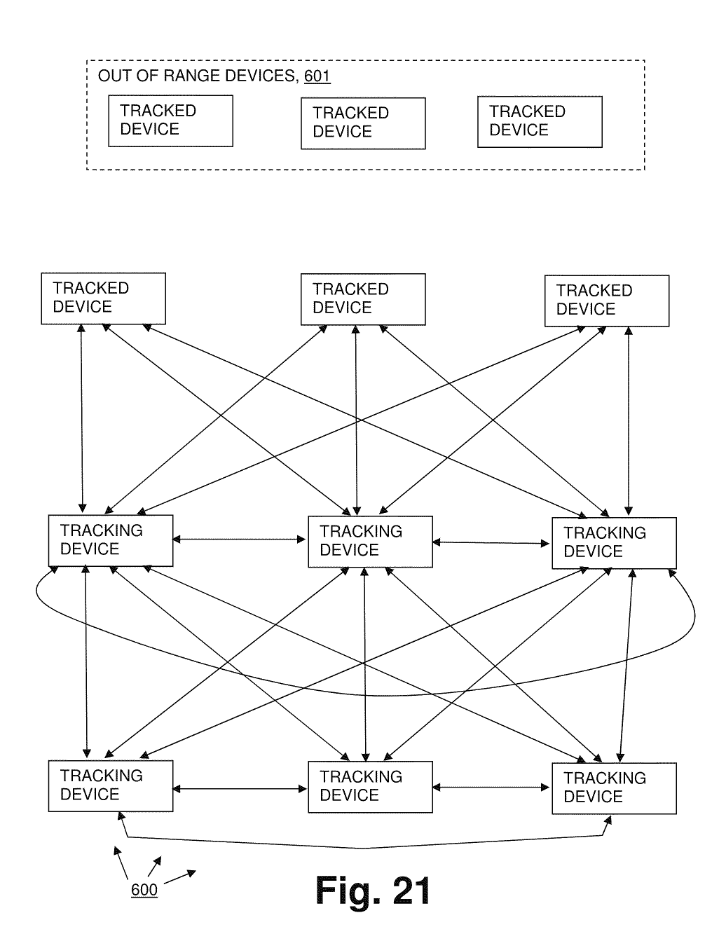

As mentioned above, some embodiments of the present invention include mesh networks. Some additional discussion of mesh networks, with reference to FIGS. 21 to 23 will now be provided. Mesh networking is a type of networking where at least some of the client nodes (or end-user nodes) in the network act as independent routers, servers and/or signal relayers, regardless of whether the client nodes are connected to another network or not. This is different than, for example, a cell telephone network where the client nodes, which are cell phones, do not act as independent routers. In this document, “serverless mesh networks” will be used to more particularly describe mesh networks which have no components that act as servers, independent routers and/or information relays, other than (some or all) client nodes. In some mesh networks each and every node is capable of capturing and disseminating data from every other node with which the node is in data communication—the present document will refer to these as “ideal mesh networks.”

The present invention may include mesh networks. FIG. 21 shows a tracking system 600 where all of the tracking devices are client nodes that can disseminate information from all other client nodes that the tracking device is in data communication with. However, in system 600, none of the tracked devices disseminate information received from other tracking devices and/or tracked devices. For example, the out-of-range tracked device nodes 601 are all out of range of every single tracking device, so they are not communicating data to any other client node.

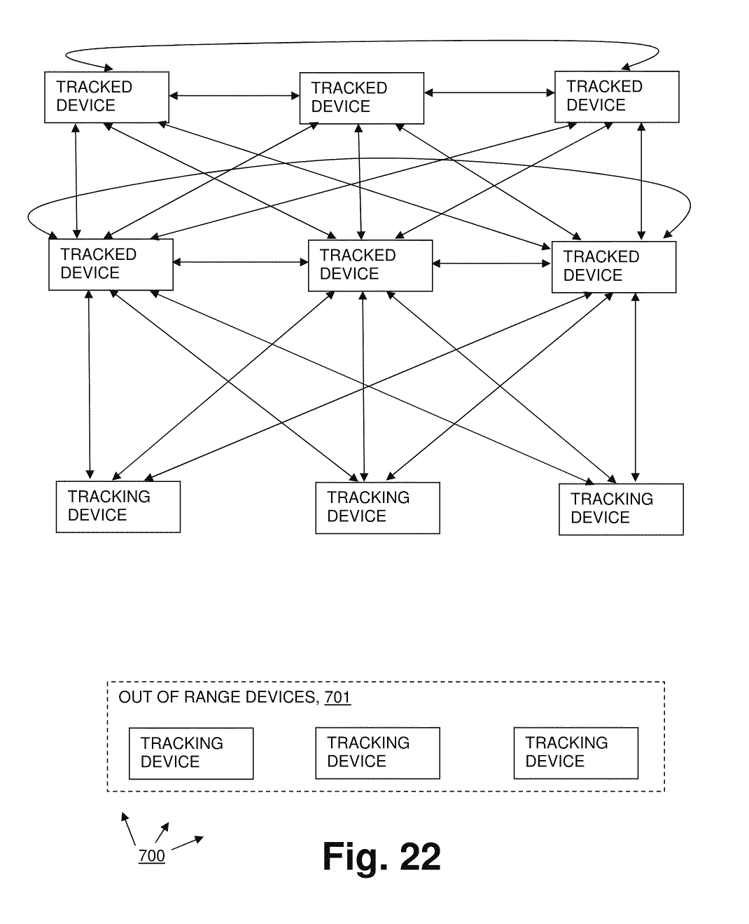

FIG. 22 shows a tracking system 700 where all of the tracked devices are client nodes that can disseminate information from all other client nodes that the tracked device is in data communication with. However, in system 700, none of the tracking devices disseminate information received from other tracking devices and/or tracked devices. For example, the out-of-range tracking device nodes 701 are all out of range of every single tracked device, so they are not receiving data from any other client node.

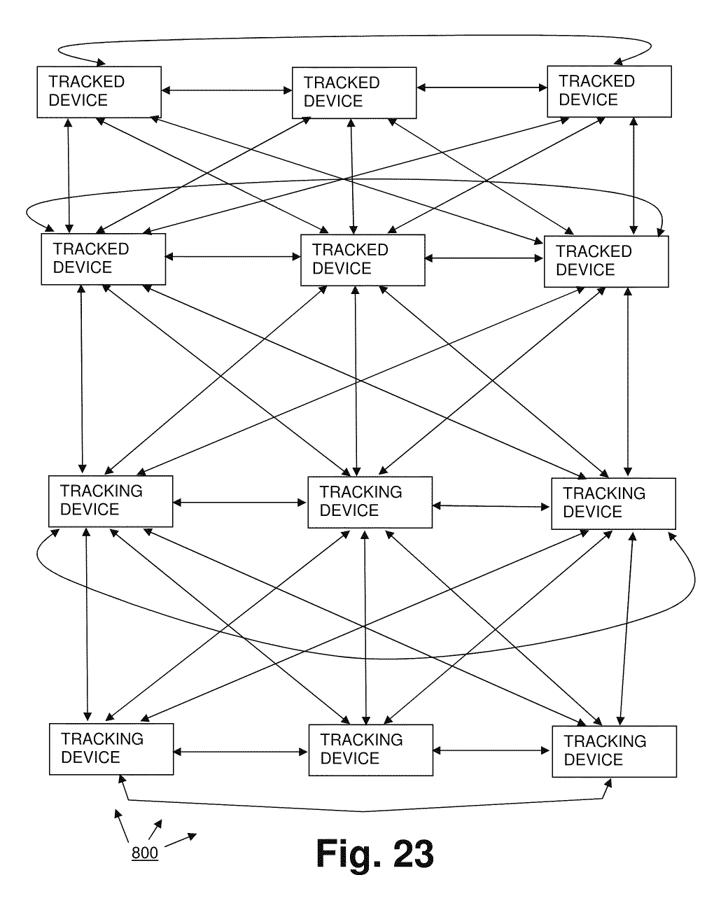

FIG. 23 shows a tracking system 800 where all of the tracking devices and all of the tracked devices are client nodes that can disseminate information from all other client nodes that the (tracked or tracking) device is in data communication with. System 800 is a tracking system in the form of an ideal mesh network. There are many possible embodiments, besides those of FIGS. 21 to 23, where only some tracked nodes and/or only some tracking nodes act as a router, server and/or relayer.

Some hardware components that can be used to make tracking system mesh networks according to the present invention can be found at the following web addresses: (i) http://www.digi.com/products/wireless-wired-embedded-solutions/zigbee-rf-modules/zigbee-mesh-module/xbee-zb-module.jsp#overview; (ii) http://www.microchip.com/stellent/idcplg?IdcService=SS_GET_PAGE&nodeId=2112; and/or (iii) http://www.atmel.com/products/zigbee/.

While some mesh network embodiments of the present invention will use the “long range direct radio communication” described above, there may be other embodiments of the present invention that use mesh networks, and/or ideal mesh networks, in tracking systems that transmit information from tracked node to tracking nodes in ways other than by long range direct radio communication. Also, as noted above, the mesh network embodiments of the present invention are still considered to use long range radio communication so long as at least some communications from a tracked device to a tracking device are made by long range direct radio communication (for example, not through a cell phone network or internet network).

As used in this document, the words receive, provide, send, input, output (unless otherwise explicitly specified) should not be taken to imply: (i) any particular degree of directness with respect to the relationship between their objects and subjects; and/or (ii) absence of intermediate components, actions and/or things interposed between their objects and subjects.

As used in this document, the term “positional information” shall not be taken to imply: (i) any particular degree of accuracy; (ii) any particular degree of precision; and/or (iii) absolute (as contrasted with relative) position.

What is claimed is:

1. A tracking system comprising:
a tracking device; and
a tracked device;
wherein:
the tracking device comprises a computer and a base radio receiver;
the computer comprises tracking software;
the tracked device comprises a position determination sub-system and a tracked radio transmitter;
the position determination sub-system is structured and/or connected to determine positional information relating to the location of the tracked device and to communicate this information to the tracked radio transmitter;
the base radio receiver and tracked radio transmitter are structured so that the tracked radio transmitter transmits the positional information to the base radio receiver by long range direct radio communication; and
the base radio receiver is structured and/or connected to communicate the positional information to the tracking software.

2. The system of claim 1 wherein:
the computer further comprises a user interface;
the tracking software is programmed to communicate the positional information to the user interface; and
the user interface is structured, connected and/or located to communicate the positional information in human readable form to a user through the user interface.

3. The system of claim 1 wherein:
the computer further comprises a data communication port;
the base radio receiver is a peripheral device; and
the base radio receiver is in data communication with the computer through the data communication port and the tracking software receives the positional information from the base radio receiver through the data communication port.

4. The system of claim 1 wherein the tracked device is sized and shaped to be small and light enough to be attached to a child or household pet.

5. The system of claim 1 wherein the base radio receiver and tracked radio transmitter are structured so that the tracked radio transmitter transmits the positional information to the base radio receiver in one or more of the following forms: Multi-Use Radio Service band standard, xbee band standard, FSK band standard, OSK band standard and/or ISM band standard.

6. The system of claim 1 wherein the base radio receiver and tracked radio transmitter are structured so that the tracked radio transmitter transmits the positional information to the base radio receiver reliably under normal operating conditions over distances greater than 300 meters.

7. A tracking kit sub-system for use in a larger tracking system comprising a smart phone type device comprising a user interface, the tracking kit sub-system comprising:
tracking software;
a dongle; and
a first tracker;
wherein:
the dongle comprises a radio transceiver;
the dongle is connectable to the smart phone type device by a wired data communication connection;
the tracking software is programmed to be installable on and to run on the smart phone type device;
the first tracker comprises a Global Positioning System sub-sub-system and a radio transceiver;
the Global Positioning System sub-sub-system is structured and/or connected to determine positional information relating to the location of the tracked device and to communicate this information to the radio transceiver of the first tracker;
the radio transceiver of the first tracker and the radio transceiver of the dongle are structured so that the radio transceiver of the first tracker transmits the positional information to the radio transceiver of the dongle by long range direct radio communication;
the radio transceiver of the dongle is structured and/or connected to communicate the positional information to the tracking software, when connected to the smart phone device, through the wired data communication connection; and
the tracking software is programmed, when installed and running on the smart phone type device, to communicate the positional information to the user interface so that the positional information will be output by the user interface in human readable form.

8. The kit sub-system of claim 7 wherein the wired data communication connection is structured as a Universal Serial Bus connection.

9. The kit sub-system of claim 7 wherein the tracking software is further programmed, when installed and running on the smart phone type device, to communicate the positional information to the user interface so that the positional information will be output against a background representing a road map.

10. The kit sub-system of claim 7 wherein the tracking software is further programmed, when installed and running on the smart phone type device, to communicate the positional information to the user interface so that the positional information will be output against a background representing a co-ordinate grid.

11. The kit system of claim 7 wherein the first tracker is sized and shaped to be small and light enough to attached to a child or household pet.

12. The kit system of claim 2 wherein the radio transceiver of the dongle and the radio transceiver of the first tracker are structured so that the radio transceiver of the first tracker transmits the positional information to the radio transceiver of the dongle in one or more of the following forms: Multi-Use Radio Service band standard, xbee band standard, FSK band standard, OSK band standard and/or ISM band standard.

13. The kit system of claim 1 wherein the radio transceiver of the dongle and the radio transceiver of the first tracker are structured so that the radio transceiver of the first tracker transmits the positional information to the radio transceiver of the dongle reliably under normal operating conditions over distances greater than 300 meters.

14. A method, performed by processing hardware of a computer programmed to provide functionality of tracking remote objects in conjunction with user interface, a long range direct radio transceiver, a Global Positioning System sub-system and an internet network communication sub-system, the method comprising the steps of:
selecting, by the user through the user interface, of a remote object to track;
determining which of the following alternative conditions is applicable: condition (i) the long range direct radio transceiver, the Global Positioning System sub-system and the internet network communication sub-system are all available; condition (ii) the long range direct radio transceiver and the Global Positioning System sub-system are available, but the internet network communication sub-system is not available; or condition (iii) the long range direct radio transceiver is available, but the Global Positioning System sub-system and the internet network communication sub-system are not available;
receiving positional information of the remote tracked object by the long range direct radio transceiver through long range direct radio communications from the remote tracked object;
if the determining step determines that condition (i) applies, then:
assembling positional relating to the remote tracked object received at the receiving step by the long range direct radio transceiver with information from the Global Positioning sub-sub-system and the internet network communication sub-sub-system to generate a condition (i) type display indicating the position of the remote tracked object, and
displaying the condition (i) type display through the user interface in human readable form;
if the determining step determines that condition (ii) applies, then:
assembling positional relating to the remote tracked object received at the receiving step by the long range direct radio transceiver with information from the Global Positioning sub-sub-system to generate a condition (ii) type display indicating the position of the remote tracked object, and
displaying the condition (ii) type display through the user interface in human readable form; and
if the determining step determines that condition (iii) applies, then:
generating a condition (iii) type display indicating the position of the remote tracked object received at the receiving step by the long range radio transceiver, and
displaying the condition (iii) type display through the user interface in human readable form.

15. The method of claim 14 wherein the processing hardware is processing hardware of a smart phone type device.

16. The method of claim 14 wherein the communications received at the receiving step are in one or more of the following forms: Multi-Use Radio Service band standard, xbee band standard, FSK band standard, OSK band standard and/or ISM band standard.

17. The method of claim 14 wherein the communications received at the receiving step are received from the remote tracked object at a distance of greater than 300 meters.
